(19) United States
(12) Patent Application Publication
(10) Pub. No.: US 2004/0068713 A1
(43) Pub. Date: Apr. 8, 2004

(54) System and method for managing distributed software development

(76) Inventors: Nicholas Yannakoyorgos, London (GB); Colin T. Lewis, Sevenoaks (GB); William E. Lockard, Raleigh, NC (US); Ade S. Onigbanjo, London (GB); Jim M. Lynch, London (GB)

Correspondence Address: MILBANK, TWEED, HADLEY & MCCLOY LLP, 1 CHASE MANHATTAN PLAZA, NEW YORK, NY, 10005-1413, US

(21) Appl. No.: 10/065,314

(22) Filed: Oct. 2, 2002

(51) Int. Cl. G06F 9/44

(52) U.S. Cl. 717/101; 717/120; 717/124

(57) ABSTRACT

The method and system provides for concurrent software code development across multiple software code repositories or within a single software code repository. Following identification of projects scheduled for completion in the development cycle, development begins within each code repository with the creation of functional delivery or development packages. Once completed, the functional development packages are submitted for approval by managers and code owners. Code developed in the different repositories or within the single repository may have conflicts or omissions, and those conflicts or omissions are automatically identified. After resolution of the conflicts or omissions, the code is tested, versioned and released into the production environment.

### BACKGROUND OF INVENTION

1. Field of the Invention

The invention relates to management of software code development, and more particularly to code development in an environment without continuous connection to a single software code repository or with multiple code repositories.

2. Description of the Related Art

Complex software code development and maintenance involves the cooperation of multiple developers. In some circumstances the developers are able to use a centralized software code repository and supporting tools to manage the development, testing and release of the code into a production environment. One such tool used in SMALLTALK code development is ENVY/Developer, which is generally described in Mastering ENVY/Developer, Pelrine, J. et al., Cambridge University Press, 2001, the disclosure of which is incorporated herein by reference.

While these tools provide certain development, management and tracking capabilities, they are not well suited to software development where the development environments are physically separate, such as might occur with developers located in both North America and Europe. The tools are also not well suited to development without continuous connection to a single code repository.

Tools are needed to support software development using more than one software repository where developers are not limited by development that is occurring in another repository. Tools are also needed to automatically identify conflicts or omissions during development using multiple repositories, as well as conflicts or omissions using a single repository. Finally, tools are needed to automatically notify code owners of completed code that is ready for approval.

The preceding description and citation of the foregoing documents is not to be construed as an admission that any of the description or documents are prior art relative to the present invention.

### SUMMARY OF INVENTION

In one aspect, the invention provides a method and system for managing software code development across a plurality of software code repositories. The method includes the steps of: identifying projects for a software development cycle; initiating concurrent software code development as functional development packages in at least two software code repositories; approving the functional development packages within each of the software code repositories; identifying omissions or conflicts between the approved functional development packages; resolving the omissions or conflicts between the functional development packages; and releasing the functional development packages.

In another aspect, the invention provides a method and system for approving projects for the software development cycle.

In another aspect, the invention provides a method and system for submitting the functional development packages for system testing.

In another aspect, the invention provides a method and system for regression testing.

In another aspect, the invention provides a method and system for submitting the functional development packages for manager approval.

In another aspect, the invention provides a method and system for automatically submitting the functional development packages for code owner approval.

In another aspect, the invention provides a method and system for applying the functional development packages to a development map within each software code repository.

The foregoing specific objects and advantages of the invention are illustrative of those which can be achieved by the present invention and are not intended to be exhaustive or limiting of the possible advantages that can be realized. Thus, the objects and advantages of this invention will be apparent from the description herein or can be learned from practicing the invention, both as embodied herein or as modified in view of any variations which may be apparent to those skilled in the art. Accordingly, the present invention resides in the novel parts, constructions, arrangements, combinations and improvements herein shown and described.

### BRIEF DESCRIPTION OF DRAWINGS

The foregoing features and other aspects of the invention are explained in the following description taken in conjunction with the accompanying figures wherein:

FIG. 1 illustrates a system according to one embodiment of the invention;

FIGS. 2A and 2B illustrate steps in a method according to one embodiment of the invention; and

FIG. 3 illustrates steps in a method according to one embodiment of the invention.

It is understood that the drawings are for illustration only and are not limiting.

### DETAILED DESCRIPTION

Software development for complex business applications is typically an on-going process even after an application is deployed and used in a production environment. This is particularly true in the financial or banking community where analysis and modeling tools are under constant revision and enhancement. The result is often a continuous and never-ending development cycle. To accommodate this continuous development cycle, while maintaining management insight and approval of the changes, in addition to version control of the changes, a number of techniques are used. Most of these techniques involve off-line development and testing of the software upgrades, with approval, versioning and deployment of the upgrades into the production environment following successful testing. Scheduling and timing of the version upgrades into the production environment is important.

With large-scale applications spanning many business units, there are typically multiple developers responsible for different pieces of the application. These developers may not be physically co-located. Therefore, coordinating development across multiple developers at distributed locations is important. Where multiple developers are working on the application and upgrades, one technique to manage potentially conflicting changes by different developers is a process whereby all code module or sections are maintained or tracked in a central repository or library and when changes are required, particular modules or sections are “checked-out” to a particular developer or code owner While the developer or owner has the code checked-out they can make changes or have changes made under their direction. Once changes are made and the module or section is “checked-in,” another developer or owner may then check-out the module to make further changes. There are many variations of this type of check-out and check-in development process. It is possible that with a check-out and check-in development process, only one “code owner” can approve any changes to particular modules or sections. Some development processes do not have a strict check-out and check-in process but use other tracking techniques with a single code repository.

With some of these techniques, a single centralized code repository or library facilitates the code check-out and check-in. This avoids the need for coordination between code libraries or repositories. In some environments, a single code repository is a satisfactory solution. However, there are circumstances where multiple code repositories are desired. Additionally, even where a single repository is otherwise satisfactory, it may be desirable for developers to work concurrently on the same parts of an application. This is often not possible where the modules are controlled under a central check-out and check-in development protocol organized around a single software code repository.

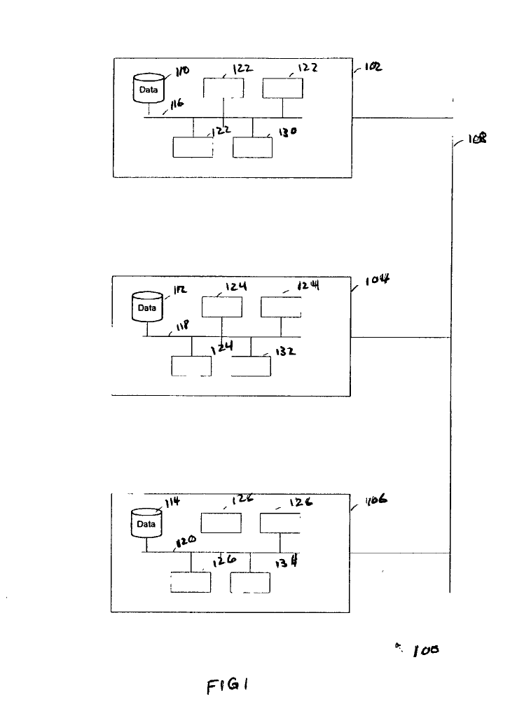

Referring now to FIG. 1, a system 100 according to one embodiment of the invention includes: development locations 102, 104, 106, which are electronically interconnected by a network 108. At each development location 102, 104, 106, there are software code repositories 110, 112, 114, which are interconnected by networks 116, 118, 120 to developer workstations 122, 124, 126. Workstations for development managers or code owners 130, 132, 134 are also connected to the code repositories 110, 112, 114 by networks 108, 116, 118 and 120, as well as being connected to developer workstations 122, 124, 126. Workstations 122, 124, 126, 130, 132, 134 are typical computer workstations with central processors, dynamic and static memory, network busses, input/output and display devices, fixed and removable code storage devices and network interface devices. Workstations 122, 124, 126, 130, 132, 134 run applications for managing distributed software development such as ENVY/DEVELOPER for SMALLTALK code development. Networks 108, 116, 118, 120 are typical wired or wireless networks such as Ethernet, Token Ring, LAN, WAN and the Internet using any of a variety of transport media (coaxial, twisted pair, radio frequency, fiber optic, etc.) and transport protocols (TCP/IP, HTTP, HTML, etc.).

With the embodiment of FIG. 1 as an example system, it is helpful to understand how a software development cycle using the invention can be accomplished. There are two main sources of requirements that drive a software development program. In a requirements based development/upgrade environment, the primary source is directly from the business sponsor of the application itself and the secondary source is from within the development team itself. To capture requirements from the business sponsor of the application, a meeting takes place between the business sponsor and the software management team to discuss future requirements, current development and implementation. This forum is a control meeting where projects are defined, scheduled and reviewed. The result is a prioritized list of development projects. From these meetings developers/analysts create business requirement documents, which are subsequently reviewed by the business sponsor before beginning any specific development. Once approved by the business sponsor, these requirement documents are then used as the basis for code development.

Although the primary driver for development comes from the business sponsor, many aspects of infrastructure development are external and not directly driven by the business sponsor. Examples of external requirements include: operating system upgrades, vendor system upgrades, building of code development tools, and audit requirements. These projects are also presented to the business sponsor at the planning meetings as either baseline work or projects that are critical to the continued operation of the application.

Once the list of projects is approved, development is scheduled and resourced by the management team. The developers and the business sponsor have regular reviews of the development to ensure that the requirements are being met. At the end of this iterative process, the new functionality embodied in the revised software is placed into the regression-testing environment where the software completes regression tests. Any new code functionality is also specifically tested with recourse to the original requirements documentation.

Upon satisfactory completion of the testing phase, a user acceptance test environment is created. This test environment allows the business sponsors to verify that the new development meets their requirements. This test environment is isolated from, but closely mimics the production environment. Once the new development completes user acceptance tests, the business sponsors formally sign-off on the new functionality.

Upon satisfactory completion of user acceptance testing, the new development of the application is packaged into a production version by the release manager and scheduled for rollout into the production environment.

To accommodate this type of development and testing, it is helpful to have an isolated development environment, which permits the developers to iteratively develop new business functionality. The development environment includes copies of the production databases and copies of the production application. The production database accounts are removed and development only accounts are created as part of the process to move the databases into development. These databases may have had their definitions altered as per requirements of the current development functionality. These databases are available at all times to permit the developer to verify that the new functionality integrates correctly with the current environment.

At the beginning of each development day, a new version of the development application is rebuilt. This development application is constructed from the native application, which is provided as it comes from the vendor. This incremental environment includes all code released by the developers up to that point.

In one example, the development teams are geographically distributed in London, New York and Tokyo. There is a central repository for all code, located on a master machine resident at one of those locations. This master machine has a backup strategy. For convenience, there are a number of local copies of this repository in each of the development sites. The infrastructure team has created additional development tools to manage synchronizing these repositories and to provide improved productivity for this tailored environment. This tool is known as the Functional Delivery Package or Functional Development Package (FDP).

Once a new development environment is successfully built, a number of automated tests are performed to ensure that the environment is still consistent with the production environment. A wide range of business tests are run to provide some indication of the quality of the application. This process is an automated process known as the smoke test and produces notifications on an exception basis. When required, the smoke test can be run interactively by developers. Once new functionality has successfully made its way into the production environment, the smoke tests are reviewed to ensure that they provide appropriate coverage of the most used business functionality.

Due to the complexity of managing a number of physically separate development environments (e.g., London, New York and Tokyo), one embodiment of the invention permits developers to synchronize their code with the master code repository. As an example, this capability is built on top of ENVY/DEVELOPER, which is a code management package. This capability allows developers to combine disparate classes, potentially owned by other developers, into a package of code (FDP), which satisfies a particular business requirement. Once created, the FDP is then submitted to the developer's manager for approval and subsequently to other developers—the owners of the classes—for approval. The class owners are responsible for ensuring that the additional functionality is appropriate and conforms to the code standards. The class owners can either reject the particular version of the class with suggestions for improvement, or else approve the class if they are satisfied with it. Once the developer has received approvals for all the class versions stored in their FDP from all the class owners, the developer can then apply that particular version of the FDP to the open development map. Once applied to the open development map, this code will subsequently be included in any later development application build.

Once code development management and the business sponsor have decided upon the release schedule, all developers work to ensure that their code changes are released into the open development map in time for the development close. The development close is scheduled to allow adequate regression testing of the application plus sufficient user acceptance testing in all appropriate sites. The first version of a test map is created when the development map closes. The Release Manager closely controls the test map. All changes to the test environment are subject to review and specific, targeted re-testing.

The testing process itself is dependent upon the specific functionality which has been added to the application but will, as a minimum, contain verification of the following: mark-to-market of all official trades; all end-of-day batches; all overnight batches; market environment generation; and all feeds to external systems.

The verification process involves creating copies of the production database, production application and all output results for a specific day. This environment is available throughout the testing cycle and is known as the baseline environment. A parallel environment exists with the new version of the applications required and the same financial calculations are exercised to produce new results. These results are then compared against the baseline results to determine if the applications are operating as expected.

Any software bugs or errors that are detected in this phase are passed on to the appropriate developer. Once a fix has been created using the FDP process, the Release Manager applies this fix to the test map. The test image is then rebuilt and re-tested by the testing team to confirm that the bug or error has been correctly fixed.

After appropriate testing in the testing environment, the application is ready for user acceptance testing in the user acceptance testing environment.

A copy of the production environment is available for the users to perform acceptance testing of the application. This environment permits the business sponsors to sign-off on new business functionality and verifies existing functionality before the application is rolled into the production domain.

After successful completion of the testing stages and sign-off from the business sponsor, the application is ready to be deployed into the production environment. The Release Manager constructs the final production map and builds a production application from this map. Other configuration changes and upgrade procedures are documented in a hand-over document that is distributed to the Desk Support teams. The Release Manager compiles a release document containing all the functional changes to the application. This document is published to the business sponsor community and Desk Support teams.

The rollout procedure involves the Release Manager, the infrastructure teams and the Desk Support teams. Detailed planning is involved in each release to the production environment. A snapshot of the production database is taken as a rollback option if required. Releases may be scheduled during down-time to allow for sufficient time to perform the upgrade process and rollback, if necessary.

Should it be required, rolling back the application release can be performed by reinstating the snapshot of the production database prior to application upgrade or reinstating the previous versions of the application(s) (rolling back the application version).

Emergency fixes can be applied to the production environment by the Desk Support teams. The Desk Support Manager controls this process. The application can be “scratched” to contain a temporary fix to the production application. This fix is then subsequently released into the development environment and potentially a test environment if one exists at that time. The Release Manager will rebuild a production map as soon as practicable after the emergency fix has been applied. This provides management and the business sponsors with an auditable record of application changes to the production environment.

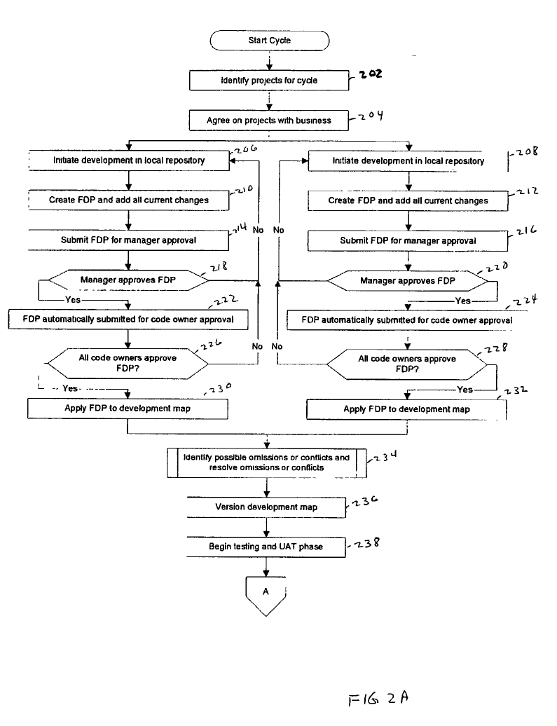

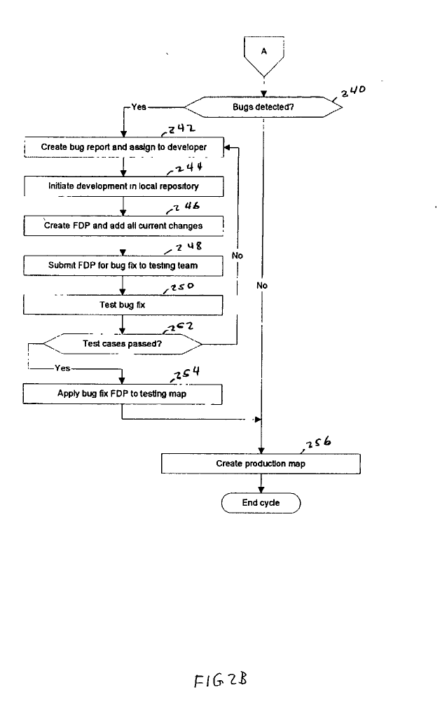

Having described embodiments of the invention in general terms, it is helpful to refer to FIG. 2 for a specific example. At steps 202, 204, representatives of the business sponsor and the development team meet to identify and agree on projects for the development cycle. As part of this process, a list of projects and the requirements are documented. This project list and the associated requirements are used throughout the development cycle.

At steps 206, 208, development begins using multiple repositories. The multiple repositories are typically in different and separate locations.

At steps 210, 212, developers using the different repositories create Functional Delivery or Development Packages (FDP) and add the code changes to the FDP. Each FDP that is scheduled for release within the current development cycle is registered by the Release Manager, and only code that is within a registered FDP and has been approved will be released. It is possible to have an unregistered FDP and to add changes to the unregistered FDP, but it will not be released until it is registered by the Release Manager and approved. The FDP includes some or all of: the code required; a short description; the business sponsor and developer name(s); reference to the functional specification and description of the change; upgrade/migration/data manipulation scripts and/or instructions; reference to the originating request; reference to the completed unit test plan; and tests to add to the test harness and smoke tests.

Once all of the changes are added to the FDP, then at steps 214, 216, the FDPs are submitted to respective manager (130, 132, 134) for approval. As part of the submit, the FDP is propagated to the other code repositories so that the reviewing manager and/or reviewing code owners can be working in different locations from the developer submitting the change.

Once the managers have approved the FDPs at steps 218, 220, then at steps 222, 224 the FDPs are automatically submitted to the code owner (130, 132, 134) for approval. In one embodiment, there is “group” class ownership, in addition to individual ownership. This is to remove the bottleneck associated with occasional delays in releasing classes by owners. In this embodiment, any member of the specified group can approve changes as the owner.

At steps 218, 220, one reason a manager might disapprove an FDP is because the FDP does not reflect one of the projects that were identified and agreed at steps 202, 204.

Once the code owners have approved the FDPs at steps 226, 228, then at steps 230, 232, the FDPs are applied to the development map.

Through steps 232, the code development using the different repositories has been generally uncoordinated, and where there are no conflicts, this type of parallel and uncoordinated development can be faster. However, changes by developers working in different code repositories may conflict.

At step 234, the changes from the FDPs in different repositories are compared to identify possible omissions or conflicts. The omissions or conflicts are then resolved. Depending on how significant the omissions or conflicts are, the resolution process may be recursive (looping back to steps 206, 208 for resolution). Alternatively, the omissions or conflicts may be handled by one of the developers.

Once any omissions or conflicts are resolved, then at step 236 the development map is versioned, and at step 238, regression testing and user acceptance testing begins.

In the course of testing, bugs or errors may be detected at step 240, leading at step 242 to creation of a bug report and assignment of the bug to a developer.

At step 244, the developer initiates development in a local repository. This includes creating an FDP and adding current changes to the FDP (step 246).

At steps 248, 250, the FDP is submitted to the testing team and tested at step 252.

If the testing is successful, then at step 254, the bug fix FDP is applied to the testing map, and upon successful completion, at step 256 the release manager creates the production map. This completes one cycle, after which the process repeats for another cycle starting at step 202.

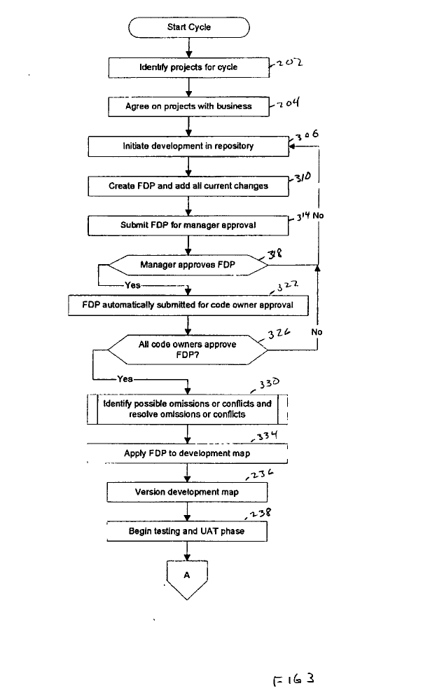

The embodiments described to this point focus on the use of two software code repositories. It is also possible to apply aspects of the invention with a single software code repository. Referring now to FIG. 3, at steps 202, 204, representatives of the business sponsor and the development team meet to identify and agree on projects for the development cycle. These steps are the same or similar to the steps illustrated in FIG. 2 and described above.

At step 306, development begins using a single code repository. The developers may have continuous access to this single repository, or they may not have continuous access to the repository. Aspects of the invention are particularly applicable to development without continuous access to the repository.

At step 310, developers create FDPs and add the code changes to the FDPs. The FDPs are the same as previously described.

At step 314, the FDPs are submitted to the manager for approval at step 318. Once approved by the manager, then at step 322, the FDPs are automatically submitted to the code owner for approval.

At step 330, once approved by the code owners, the FDPs are compared to identify possible omissions or conflicts, and resolve the omissions or conflicts. This identification of possible omissions or conflicts, using a single repository, allows concurrent development in a single repository without the need for a rigid check-out and check-in procedure.

After resolution of omissions or conflicts, then at step 334 the FDPs are applied to the development map for versioning, testing, and release as illustrated and described with relation to FIG. 2.

In the description above, some of the steps use existing development tools, such as ENVY/DEVELOPER. Other steps use embodiments of the invention or a combination of existing tools and embodiments of the invention. In particular, although steps 206, 208, 306 individually use some existing ENVY/DEVELOPER functions, the ability to manage development across multiple repositories is not resident in ENVY/DEVELOPER. Similarly, at steps 210, 212, 310 although ENVY/DEVELOPER has some ability to create parts of an FDP, the invention adds additional capability to track the changes.

Using the capabilities of ENVY/DEVELOPER without the invention, the process at steps 222, 224 or 324 is manual, with the developer requesting code approval from the code owner. In one embodiment, the invention automates the code approval process at steps 222, 224, 324.

Similarly, using the capabilities of the invention, once all code owners approve of the FDP at steps 226, 228, 326, then applying the FDP to the development map at steps 230, 232, 334 is automatic. Finally, using the capabilities of the invention, versioning at step 236 can be reduced to a single keystroke.

In the described examples as illustrated in the figures, the steps are performed in a particular order. However, the order for performing the steps is not limited to the illustrated examples. For instance, in FIG. 3, step 330 can be performed between steps 318 and 322 or between steps 322 and 326. Similarly, in FIG. 2, step 234 can be performed between steps 218 and 222 or between steps 222 and 226.

Although illustrative embodiments have been described herein in detail, it should be noted and will be appreciated by those skilled in the art that numerous variations may be made within the scope of this invention without departing from the principles of this invention and without sacrificing its chief advantages.

The embodiments described above address development that is scheduled and completed within a single development cycle. However, in some cases, the time for development will be longer than the time of a single development cycle. In that case, the development code is held within an unregistered FDP, and not released into the development map. During the scheduled release cycle, the FDP is registered and after approval, the code is released into the development map.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A method for managing software code development across a plurality of software code repositories, the method comprising:
identifying projects for a software development cycle;
initiating concurrent software code development as functional development packages in at least two software code repositories;
approving the functional development packages within each of the software code repositories;
identifying omissions or conflicts between the approved functional development packages;
resolving the omissions or conflicts between the functional development packages; and
releasing the functional development packages.

2. A method according to claim 1, further comprising:
approving projects for the software development cycle.

3. A method according to claim 1, further comprising:
submitting the functional development packages for system testing.

4. A method according to claim 1, further comprising:
regression testing the functional development packages.

5. A method according to claim 1, further comprising:
submitting the functional development package for manager approval within the respective software code repository.

6. A method according to claim 1, further comprising:
automatically submitting the functional development packages for code owner approval.

7. A method according to claim 1, further comprising:
applying the functional development packages to a development map within each of the software code repositories.

8. A method according to claim 1, further comprising:
testing the released functional development packages.

9. Computer executable software code transmitted as an information signal, the code for managing software code development across a plurality of software code repositories, the code comprising:
code to identify projects for a software development cycle;
code to initiate concurrent software code development as functional development packages in at least two software code repositories;
code to approve the functional development packages within each of the software code repositories;
code to identify omissions or conflicts between the approved functional development packages;
code to resolve the omissions or conflicts between the functional development packages; and
code to release the functional development packages.

10. A computer-readable medium having computer executable software code stored thereon, the code for managing software code development across a plurality of software code repositories, the code comprising:
code to identify projects for a software development cycle;
code to initiate concurrent software code development as functional development packages in at least two software code repositories;
code to approve the functional development packages within each of the software code repositories;
code to identify omissions or conflicts between the approved functional development packages;
code to resolve the omissions or conflicts between the functional development packages; and
code to release the functional development packages.

11. A programmed computer for managing software code development across a plurality of software code repositories, comprising:
a memory having at least one region for storing computer executable program code; and
a processor for executing the program code stored in the memory; wherein the program code comprises:
code to identify projects for a software development cycle;
code to initiate concurrent software code development as functional development packages in at least two software code repositories;
code to approve the functional development packages within each of the software code repositories;
code to identify omissions or conflicts between the approved functional development packages;
code to resolve the omissions or conflicts between the functional development packages; and
code to release the functional development packages.

12. A method for managing SMALLTALK software code development across a plurality of software code repositories, the method comprising:
identifying projects for a SMALLTALK software development cycle;
initiating concurrent SMALLTALK software code development with ENVY/DEVELOPER as functional development packages in at least two software code repositories, the code repositories at physically distinct locations;
submitting the functional development packages for manager approval within the respective software code repository;
automatically submitting the functional development packages for code owner approval;
automatically identifying omissions and conflicts between the functional development packages;
resolving the omissions or conflicts between the functional development packages;
regression testing the functional development packages;
approving the functional development packages; and
releasing the functional development packages.

13. A method for managing software code development with a single software code repository, the method comprising:
identifying projects for a software development cycle;
initiating software code development as functional development packages in the single software code repository;
approving the functional development packages;
automatically identifying omissions or conflicts between the approved functional development packages;
resolving the omissions or conflicts between the functional development packages; and
releasing the functional development packages.

14. A method according to claim 13, further comprising:
approving projects for the software development cycle.

15. A method according to claim 13, further comprising:
submitting the functional development packages for system testing.

16. A method according to claim 13, further comprising:
regression testing the functional development packages.

17. A method according to claim 13, further comprising:
submitting the functional development package for manager approval within the respective software code repository.

18. A method according to claim 13, further comprising:
automatically submitting the functional development packages for code owner approval.

19. A method according to claim 13, further comprising:
applying the functional development packages to a development map within each of the software code repositories.

20. A method according to claim 13, further comprising:
testing the released functional development packages.

21. A method for managing SMALLTALK software code development with a single software code repository, the method comprising:
identifying projects for a SMALLTALK software development cycle;
initiating SMALLTALK software code development as functional development packages in the single software code repository;
submitting the functional development packages for manager approval;
automatically submitting the functional development packages for code owner approval;
automatically identifying omissions or conflicts between the functional development packages;
resolving the omissions or conflicts between the functional development packages;
regression testing the functional development packages;
approving the functional development packages; and
releasing the functional development packages.
